(19) United States
(12) Patent Application Publication
(10) Pub. No.: US 2017/0169150 A1
(43) Pub. Date: Jun. 15, 2017

(54) METHOD FOR SYSTEM SIMULATION AND NON-TRANSITORY COMPUTER-READABLE RECORDING MEDIUM THEREOF

(71) Applicant: INDUSTRIAL TECHNOLOGY RESEARCH INSTITUTE, HSINCHU (TW)

(72) Inventors: YAO-HUA CHEN, FANGYUAN TOWNSHIP (TW); CHE-WEI HSU, TAIPEI CITY (TW); JUIN-MING LU, HSINCHU CITY (TW); TING-SHUO HSU, MAGONG CITY (TW); JING-JIA LIOU, HSINCHU CITY (TW); CHIH-TSUN HUANG, HSINCHU CITY (TW)

(21) Appl. No.: 14/982,548

(22) Filed: Dec. 29, 2015

(30) Foreign Application Priority Data
Dec. 15, 2015 (TW) 104142085

(51) Int. Cl. G06F 17/50

(52) U.S. Cl. CPC G06F 17/5036

(57) ABSTRACT

A method for system simulation includes the steps of: simulating the operation of a first circuit during N clock periods based on a first model and a simulation granularity, and adjusting the simulation granularity based on the input signal or the output signal corresponding to the first model. A non-transitory computer-readable recording medium corresponding to the method is also provided.

### CROSS REFERENCE TO RELATED APPLICATION

The present application is based on, and claims priority from, Taiwan Application Serial Number 104,142,085, filed on Dec. 15, 2015, the disclosure of which is hereby incorporated by reference herein in its entirety.

### TECHNICAL FIELD

The disclosure is related to a method for system simulation and a non-transitory computer-readable recording medium thereof.

### BACKGROUND

System simulation, such as the gate level simulation and the register-transfer level simulation, is broadly used in the process of the manufacturing of electronic products. With the system simulation, the designer is capable of aware of the possible problem in the interactions between devices. Hence, the use of the system simulation is capable of improving the yield rate and therefore reducing the production cost. However, the system simulation usually costs lots of time and therefore the procedures of design and manufacture is lengthened.

### SUMMARY

A method for system simulation in one embodiment of the disclosure comprises the steps of: simulating at least one operation of a first circuit during N clock periods based on a first model and at least one parameter of a simulation granularity, wherein the first model is corresponding to the first circuit and N is a positive integer; and adjusting the at least one parameter of the simulation granularity based on at least one input signal corresponding to the first model or at least one output signal corresponding to the first model to adjust N.

A method for system simulation in one embodiment of the disclosure comprises the steps of: selectively simulating a first circuit in a cycle mode, an event mode, or a window mode based on a signal rate; when simulating the first circuit in the window mode, simulating at least one operation of the first circuit during N clock periods based on a first model and at least one parameter of a simulation granularity, wherein the first model is corresponding to the first circuit and N is a positive integer; and adjusting the at least one parameter of the simulation granularity based on the signal rate to adjust N, wherein the signal rate is corresponding to at least one input signal corresponding to the first model or at least one output signal corresponding to the first model.

A non-transitory computer-readable recording medium corresponding to the aforementioned methods is also disclosed. The non-transitory computer-readable recording medium stores at least one program. The at least one program causing a processor to perform the aforementioned methods after the at least one program is loaded on a computer and is executed.

A non-transitory computer-readable recording medium corresponding to the aforementioned methods is also disclosed. The non-transitory computer-readable recording medium stores at least one program. When the at least one program is executed by a device, the device performs the aforementioned methods.

In order to make the aforementioned and other features of the present disclosure more comprehensible, several embodiments accompanied with figures are described in detail below.

### BRIEF DESCRIPTION OF THE DRAWINGS

The present disclosure will become more fully understood from the detailed description given herein below for illustration only, and thus are not limitative of the present disclosure, and wherein:

FIG. 1 is the flowchart of the method for system simulation based on one embodiment of the disclosure;

FIG. 2 is the architecture diagram of the simulation system based on one embodiment of the disclosure;

FIG. 3 is a timing diagram based on one embodiment of the disclosure;

FIG. 4 is a flowchart of the method for adjusting the parameter of the simulation granularity based on one embodiment of the disclosure;

FIG. 5 is a flowchart of the method for adjusting the parameter of the simulation granularity based on another embodiment of the disclosure; and

FIG. 6 illustrates the timing diagrams of the estimated error and the timing sequence compensation based on one embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

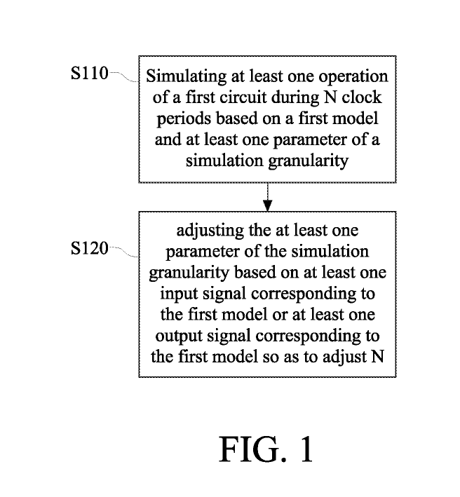

The method for system simulation based on one embodiment of the disclosure includes cycle mode, event mode and window mode, wherein the user may arbitrarily choose the mode for simulation in one embodiment, or the mode for simulation may be switched based on the signal rate. As to the operation of the window mode, please refer to FIG. 1, which is the flowchart of the method for system simulation based on one embodiment of the disclosure. As shown in FIG. 1, the disclosed method for system simulation includes the steps as: In step S110, at least one operation of a first circuit during N clock periods is simulated based on a first model and at least one parameter of a simulation granularity, wherein the first model is corresponding to the first circuit and N is a positive integer. The first circuit is, for example but not limited to, the integrated circuit, the silicon intellectual property (SIP), a chip, an electronic device, or a circuit device. In functionality, the first circuit is, for example but not limited to, a central processing unit (CPU), a graphic processing unit (GPU), a memory controller, an image signal processor (ISP), an encoder, or a decoder. In step S120, the at least one parameter of the simulation granularity is adjusted based on at least one input signal corresponding to the first model or at least one output signal corresponding to the first model so that the value of N is adjusted.

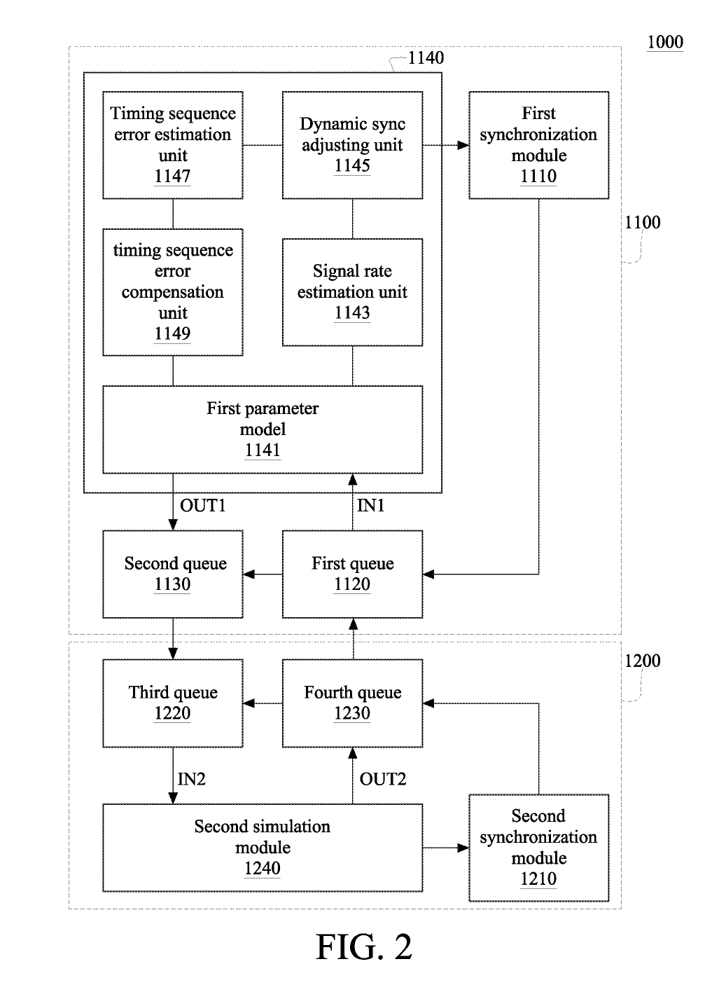

Practically, please refer to FIG. 2, which is the architecture diagram of the simulation system based on one embodiment of the disclosure. As shown in FIG. 2, the simulation system 1000 based on one embodiment of the disclosure includes the first model 1100 corresponding to the first circuit and a second model 1200 corresponding to a second circuit. Taking the first model 1100 as an example, the first model 1100 includes a first synchronization module 1110, a first queue 1120, a second queue 1130, and a first simulation module 1140. Similarly, the second model 1200 includes a second synchronization module 1210, a third queue 1220, a fourth queue 1230, and a second simulation module 1240. Also as shown in FIG. 2, the first simulation module 1140 communicates with the first queue 1120, the second queue 1130, and the first synchronization module 1110, and the first synchronization module 1110 further communicates with the first queue 1120 and the second queue 1130. In one embodiment, a module may be, for example, a circuit, a model related to a circuit, a model to simulate a circuit, or a software program, etc. In one embodiment, a module communicates with another module means that signals may be exchanged/transmitted/received between these two modules. In one embodiment, a module communicates with another module means that the two modules connect with each other directly or indirectly. In one embodiment, a module communicates with another module means that the two modules coupled to each other.

In one embodiment, the simulation system 1000 is a real hardware system. For example, the first simulation module 1140 is a central processing unit; the first queue 1120 and the second queue 1130 are registers or memory modules; and the first synchronization module 1110 is another processing unit for triggering other units.

In another embodiment, the simulation system 1000 is a system environment constructed by software program(s). The interactivities between the modules and the queues are realized by flags, pointers, function calls, and/or value responses. In another embodiment, the simulation system 1000 may be realized with the hardware description language (HDL), and may be realized in a register-transfer level (RTL) description, a behavioral level description, or a gate level description. The first circuit, for example, is the first circuit mentioned in description related to FIG. 1. The second circuit is similar to the first circuit. The first parameter model 1141, in certain example, includes an input-output look-up table and/or a delay look-up table. In other examples, it is hard to describe the operations of the circuit such as a graphic processing unit due to its characteristic of operations, so the first parameter model 1141 is may be realized by programming, equations with/without look-up table, or other suitable method so as to simulate the functionality, the transaction exchanging, and/or the in-out timing of the first circuit. In the cycle mode, the first synchronization module 1110 controls the first queue 1120 to receive input signal(s) from the second model 1200 and controls the second queue 1130 to output the output signal(s) to the second model 1200 every clock cycle. In the event mode, the first synchronization module 1110 controls the first queue 1120 to receive input signal(s) from the second model 1200 and controls the second queue 1130 to output the output signal(s) to the second model 1200 when an event occurs. In the window mode, the first synchronization module 1110 controls the first queue 1120 to receive input signal(s) from the second model 1200 and controls the second queue 1130 to output the output signal(s) to the second model 1200 every window period. In one embodiment, the first synchronization module 1110 controls the first queue 1120 to receive input signal(s) from a bus and controls the second queue 1130 to output the output signal(s) to the bus every clock cycle/event/window period in cycle mode/event mode/window mode, respectively. After the first queue 1120 receives the input signal, the input signal IN1 is inputted to the first parameter model 1141 for simulating the operations of the first circuit. The output signal OUT1 generated by the first parameter model 1141 which simulates the first circuit is output to the second queue 1130. In one embodiment, the input signal may include request commands or response signals. Similarly, the output signal may include request commands or response signals. The structure of the second model 1200 is similar to the first model 1100.

In one embodiment, the first model 1100 and the second model 1200 may be simulated in different modes. For example, the first model 1100 is simulated in the window mode, and the second model 1200 is simulated in the cycle mode. In another embodiment, the first model 1100 and the second model 1200 may have different window periods. For example, the first model 1100 is simulated in the window mode wherein the window period equals to two periods of the clock signal, while the second model 1200 is simulated in the window mode wherein the window period equals to five periods of the clock signal.

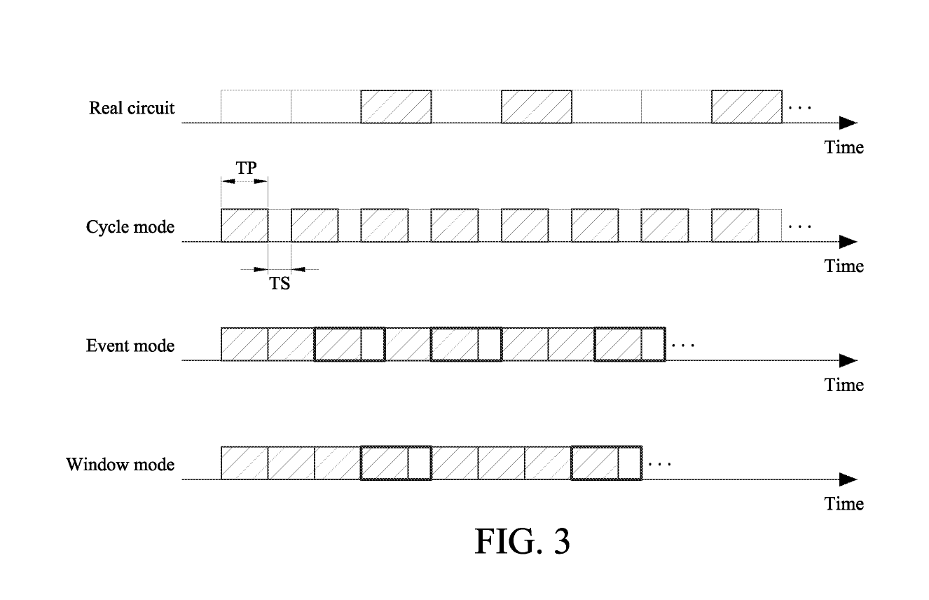

Please refer to FIG. 3, which is a timing diagram based on one embodiment of the disclosure. FIG. 3 is used for illustrating the time required, for example, for a server to simulate a circuit in the three modes in the disclosure. In this embodiment, the real circuit operates based on a clock signal, and there are events corresponding to the real circuit in the third period of the clock signal, the fifth period of the clock signal, and the eighth period of the clock signal.

In this condition, if the circuit is simulated in the cycle mode, whether an event occurs or not, the server simulates/checks the state of the circuit every cycle. Hence, it takes k*(TP+TS) for the server to simulate the operation of the circuit during k periods of the clock signal, wherein TP is the processing time to simulate the operation of the circuit within one period of clock signal and TS is the synchronization time to simulate the transaction between circuits.

If the circuit is simulated in the event mode, the server simulates/checks the state of the circuit when there is an event occurring, so it takes k*TP+Ne*TS for the server to simulate the operation of the circuit during k periods of the clock signal, wherein Ne is how many times the event occurs.

If the circuit is simulated in the window mode, it is needed to provide a value N, which means that the server simulates/checks the state of the signal exchanging between the circuits every N periods of the clock signal. N is a positive integer and the N periods of the clock signal can be seen as a window period. It takes k*TP+k*TS/N for the server to simulate the operation of the circuit during k periods of the clock signal. In other words, when the frequency of the event occurring (or the frequency of signal exchanging, the signal rate) is less than a certain threshold, simulating in the window mode takes less time than simulating in the cycle mode. When the frequency of the event occurring (or the frequency of signal exchanging, the signal rate) is larger than a certain threshold, simulating in the window mode takes less time than simulating in the event mode. For example, simulating in the window mode with N equal to 2 is faster than simulating in the cycle mode. When k/N is less than Ne, simulating in the window mode is faster than simulating in the event mode. The above is an example, and the time for simulation may be different between different simulation environments or between different circuits.

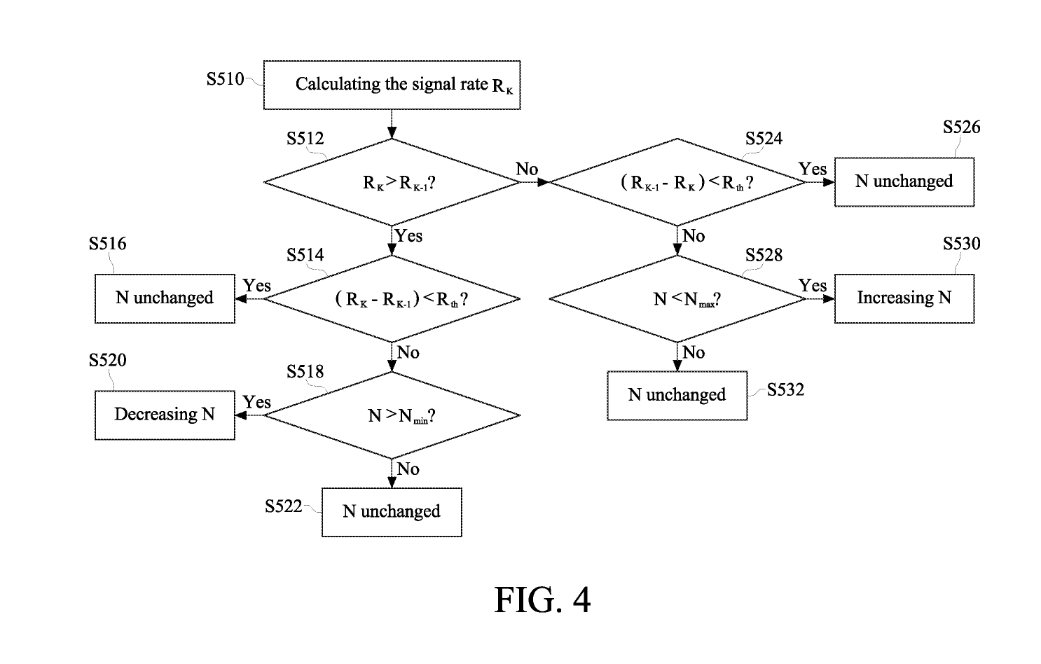

In one embodiment, taking the first simulation module 1140 for example, please refer to FIG. 2. The first simulation module 1140 includes the signal rate estimation unit 1143 and the dynamic sync adjusting unit 1145. The signal rate estimation unit 1143 calculates the signal rate Rₖ based on the amount of the output signals and/or the input signals within a certain period of time, such as in a plurality of periods of the clock signal. In one embodiment, the input signal includes the request commands or the response signals, and the output signal includes the request commands or the response signals. The dynamic sync adjusting unit 1145 adjusts at least one parameter of the simulation granularity based on the signal rate, so as to adjust N, wherein the at least one parameter of the simulation granularity, in one embodiment, may include a value of N, a upper threshold of N, a lower threshold of N, a variation threshold of the signal rate, an error value of the timing sequence, a upper threshold of the error value of the timing sequence, a lower threshold of the error value of the timing sequence, and/or other parameters for adjusting the efficiency and/or the accuracy of simulation. Please refer to FIG. 4, which is a flowchart of the method for adjusting the parameter of the simulation granularity based on one embodiment of the disclosure. In step S510, the signal rate estimation unit 1143 calculates how many request commands are received within a certain period, such as M periods of the clock signal, as the current signal rate Rₖ. In step S512, the dynamic sync adjusting unit 1145 determines whether the signal rate increases based on the current signal rate Rₖ and a previous signal rate Rₖ₋₁. If the current signal rate Rₖ is larger than the previous signal rate Rₖ₋₁, which means the signal rate increases, as shown in step S514, the dynamic sync adjusting unit 1145 determines whether the increment (Rₖ-Rₖ₋ᵢ) of the signal rate is less than the variation threshold Rₜₕ. If the increment is less than the variation threshold, as shown in step S516, the parameter(s) of simulation granularity is maintained so that the value of N is kept unchanged. If the increment is not less than the variation threshold, as shown in step S518, the dynamic sync adjusting unit 1145 determines whether the value of N is larger than the lower threshold Nₘᵢₙ. If the value of N is larger than the lower threshold Nₘᵢₙ, as shown in step S520, the dynamic sync adjusting unit 1145 adjusts the parameter(s) of simulation granularity (e.g., subtract a specific value from the value of N) so as to decrease the value of N. If the value of N is not larger than the lower threshold Nₘᵢₙ, as shown in step S522, the dynamic sync adjusting unit 1145 maintains the parameter(s) of simulation granularity so as to keep the value of N unchanged.

In the determination of the step S512, if the signal rate does not increase, as shown in step S524, the dynamic sync adjusting unit 1145 determines whether the decrement (Rₖ₋ᵢ-Rₖ) of the signal rate is less than the variation threshold Rₜₕ. If the decrement is less than the variation threshold Rₜₕ, as shown in step S526, the dynamic sync adjusting unit 1145 maintains the parameter(s) of simulation granularity so as to keep the value of N unchanged. If the decrement is not less than the variation threshold Rₜₕ, as shown in step S528, the dynamic sync adjusting unit 1145 determines whether the value of N is less than the upper threshold Nₘₐₓ. If the value of N is less than the upper threshold Nₘₐₓ, as shown in step S530, the dynamic sync adjusting unit 1145 adjusts the parameter(s) of simulation granularity (e.g., add a specific value to the value of N) so as to increase the value of N. If the value of N is not less than the upper threshold Nₘₐₓ, as shown in step S532, the dynamic sync adjusting unit 1145 maintains the parameter(s) of simulation granularity so as to keep the value of N unchanged.

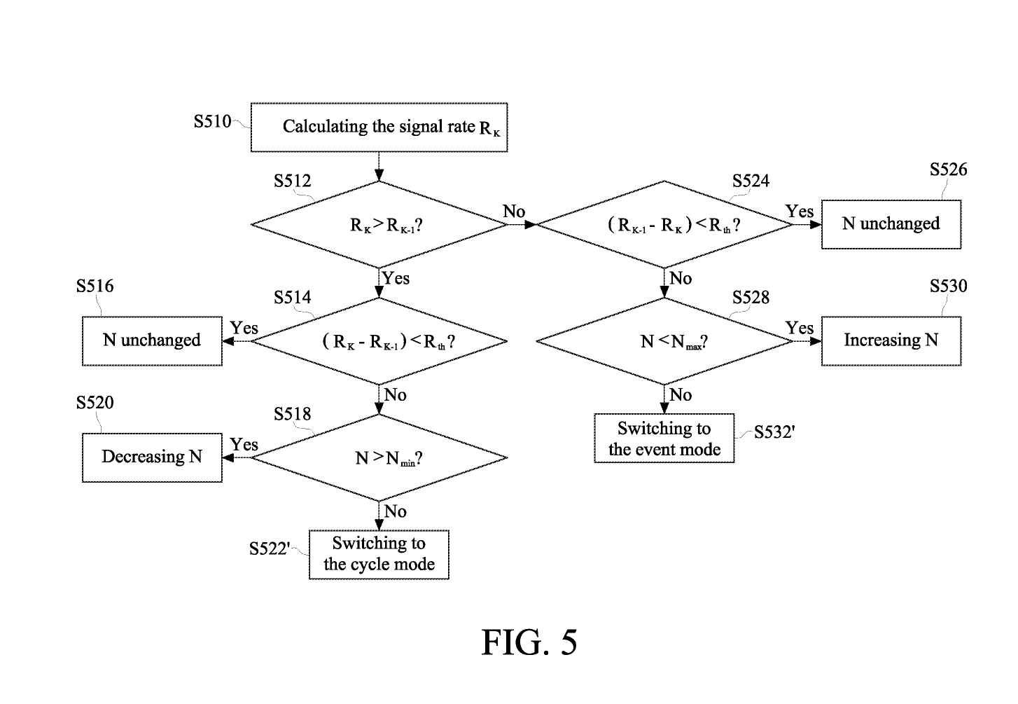

In some embodiments, please refer to FIG. 5, which is a flowchart of the method for adjusting the parameter of the simulation granularity based on another embodiment of the disclosure. The main difference between the embodiment of FIG. 5 and the embodiment of FIG. 4 is, in step S518, if the value of N is not larger than the lower threshold Nₘᵢₙ, as shown in step S522′, the simulation system 1000 switches the simulation mode from the window mode to the cycle mode. In step S528, if the value of N is not less than the upper threshold Nₘₐₓ, as shown in step S532′, the simulation system 1000 switches the simulation mode from the window mode to the event mode. In another embodiment, the lower threshold Nₘᵢₙ is 1 and the simulation mode is automatically switched to cycle mode if the value of N is equal to 1.

In one embodiment, when the first model 1100 is simulated in the cycle mode, the dynamic sync adjusting unit 1145 determines whether the signal rate is less than the upper threshold of the signal rate, and switches the simulation mode from the cycle mode to the window mode when the signal rate is less than the upper threshold of the signal rate. When the first model 1100 is simulated in the event mode, the dynamic sync adjusting unit 1145 determines whether the signal rate is larger than the lower threshold of the signal rate, and switches the simulation mode from the event mode to the window mode when the signal rate is larger than the lower threshold of the signal rate.

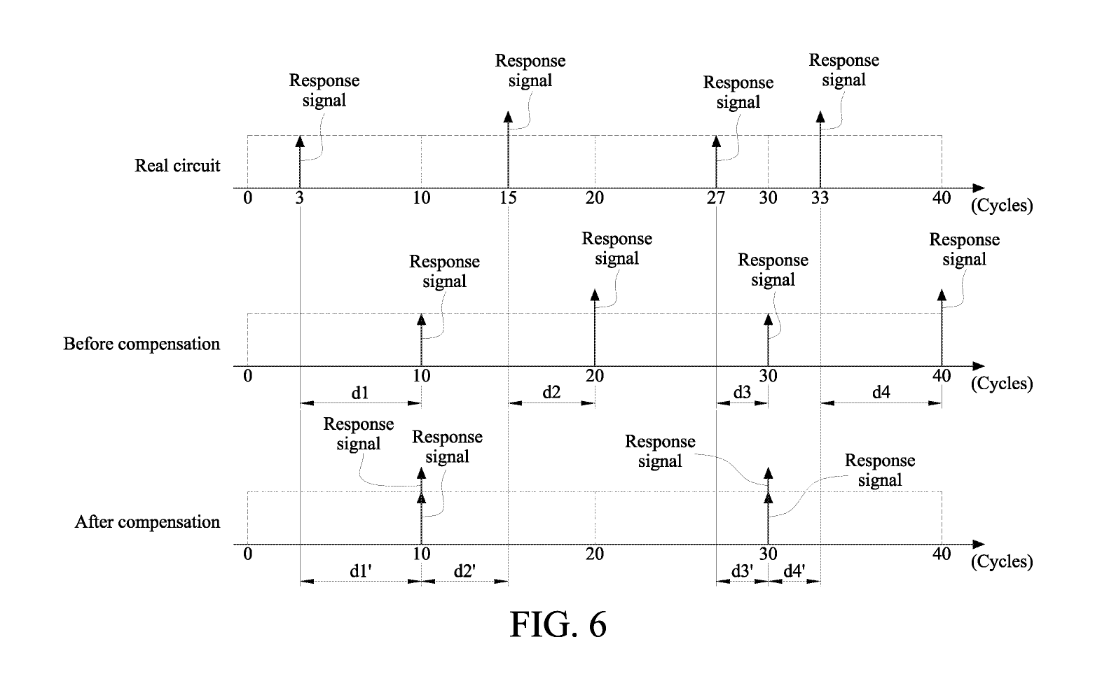

In another embodiment, please refer to FIG. 2 and FIG. 6 together, wherein FIG. 6 illustrates the timing diagrams of the estimated error and the timing sequence compensation based on one embodiment of the disclosure. From top to bottom, the first timing diagram illustrates the timing sequence of the output signal (response signal) generated by the first circuit which is corresponding to the first model 1100. The second timing diagram illustrates the timing sequence simulated by the first model 1100 with the previous method with N=10 and without compensation. The third timing diagram illustrates the timing sequence after error compensation. As shown in the timing sequence of the first timing diagram, the first circuit outputs the response signals in the third period, the fifteenth period, the twenty-seventh period, and the thirty-third period of the clock signal. As shown in the timing sequence of the second timing diagram, if the first circuit is simulated with the previous method without compensation and providing N=10, the response signals would be outputted in the tenth period, the twentieth period, the thirtieth period, and the fortieth period of the clock signal. Therefore, there are the errors d1 to d4, wherein the error d1 equals to seven periods of the clock signal, the error d2 equals to five periods of the clock signal, the error d3 equals to three periods of the clock signal, and the error d4 equals to seven periods of the clock signal. Hence, after the first model simulates the first circuit for forty periods of the clock signal without compensation, the total error value of the timing sequence reaches twenty-two periods of the clock signal, which is the summation of the error d1 to the error d4. Although sometimes the object of simulation is to determine whether the functionalities of the simulated circuit, the first circuit, are correct or not, the designers do not hope that the error value of the timing sequence in the simulation is far from the real circuit.

Hence, in one embodiment, the first simulation module 1140 further includes the timing sequence error estimation unit 1147 and the timing sequence error compensation unit 1149. The timing sequence error estimation unit 1147 calculates the accumulated error value of the timing sequence. When the response signal is outputted in the tenth period of the clock signal, the error value of the timing sequence is calculated to be 7 periods of the clock signal, which means there is delay in the current timing sequence. In this embodiment, by the calculation of the timing sequence error compensation unit 1149, it is known that if the next response signal, which is originally to be outputted in the twentieth period of the clock signal, is outputted in the tenth period of the clock signal, the accumulated error value of the timing sequence would become the summation of the error d1′(i.e., 7 periods of the clock signal) and the error d2′(i.e., −5 periods of the clock signal), which is equal to two periods of the clock signal, and is less than the summation of the error d1 (i.e., 7 periods of the clock signal) and the error d2 (i.e., 5 periods of the clock signal), which is equal to twelve periods of the clock signal.

In the thirtieth period of the clock signal, the error value of the timing sequence is increased by three periods of the clock signal (d3′) and equals to five periods of the clock signal. By calculation, the timing sequence error compensation unit 1149 would determine whether to output the response signal which is originally to be outputted in the fortieth period of the clock signal. It is calculated that if the response signal originally to be outputted in the fortieth period of the clock signal is outputted in the thirtieth period of the clock signal, the accumulated error value of the timing sequence would be reduced, so the response signal originally to be outputted in the fortieth period of the clock signal is outputted in the thirtieth period of the clock signal. Hence, after compensation, the accumulated error value of the timing sequence equals to the summation of the errors d1′ to d4′. Because the error d1′ equals to 7 periods of the clock signal, the error d2′ equals to −5 periods of the clock signal, the error d3′ equals to 3 periods of the clock signal, and the error d4′ equals to −3 periods of the clock signal, the accumulated error value of the timing sequence equals to 2 periods of the clock signal. Therefore, the accumulated error value of the timing sequence after compensation (i.e., 2 periods of the clock signal) is smaller than the accumulated error value of the timing sequence before compensation (i.e., 22 periods of the clock signal).

Hence, based on the simulation method of this embodiment, the first model 1100 checks the accumulated error value of the timing sequence every window period based on the calculation result of the timing sequence error compensation unit 1149 so as to determine whether to output the response signal. If the accumulated error value of the timing sequence can be reduced by postponing the output of the response signal for one window period, the first model 1100 would not output the response signal in the present window period but output the response signal in next window period based on the calculation result of the timing sequence error compensation unit 1149. Otherwise, the response signal is outputted in the present window period. Specifically, the error value of the timing sequence is firstly estimated or calculated when the error compensation is performed. The estimation of the error is to predict the accumulated error value of the timing sequence in the future, and the calculation of the error is to accumulate the errors in the present and in the past. In some embodiments, the timing sequence error estimation unit 1147 and the timing sequence error compensation unit 1149 perform both the estimation and the calculation, and in some embodiments, the timing sequence error estimation unit 1147 and the timing sequence error compensation unit 1149 perform only the calculation or only the estimation.

When the error value of the timing sequence is larger than zero, it means that there is delay in the timing sequence, so the first model 1100 may output part or all of the output signals in advance. When the error value of the timing sequence is less than zero, the first model 1100 may postpone outputting part or all of the output signals. Additionally, the amount of the error value of the timing sequence is capable of being used in adjust the parameter(s) of the simulation granularity so as to adjust the value of N. The method, for example, includes the steps of: decreasing the window period (i.e., the value of N) when the error value of the timing sequence is larger than a first preset threshold; and otherwise, increasing the value of N. The abovementioned first preset threshold may include more than one value. For example, the value of N can be decreased when the error value of the timing sequence is larger than the upper threshold of the error value of the timing sequence. The value of N can be increased when the error value of the timing sequence is less than the lower threshold of the error value of the timing sequence.

A non-transitory computer-readable recording medium is further provided according to one embodiment of the disclosure. In one embodiment, the non-transitory computer-readable recording medium stores at least one program. After the at least one program is loaded on a computer and is executed, the at least one program causes a processor to perform the simulation method mentioned above. In one embodiment, when the at least one program stored in non-transitory computer-readable recording medium is the executed by a device, the device performs the simulation method mentioned above. The computer-readable recording medium, for example, may be a floppy disk, a hard disk, a CD_ROM, or a flash memory.

The simulation method according to one embodiment of the disclosure is simulated and the simulation results list in Table I. It can be seen from Table I that when N increases, the efficiency of the window mode is better than the cycle mode, N=1.

TABLE I

| signal rate (number of | | | |
|---|---|---|---|
| request commands per 1000 | | simulation | |
| periods of clock signal) | N | time (s) | efficiency |
| 10 | 1(cycle mode) | 2.094 | 1 |
| 10 | 10 | 1.782 | 1.18 |
| 10 | 100 | 1.69 | 1.24 |
| 2.5 | 1(cycle mode) | 1.167 | 1 |
| 2.5 | 10 | 0.767 | 1.52 |
| 2.5 | 100 | 0.706 | 1.65 |
| 1.25 | 1(cycle mode) | 0.74 | 1 |
| 1.25 | 10 | 0.27 | 2.74 |
| 1.25 | 100 | 0.22 | 3.36 |

As above, the simulation system based on one or more embodiments of the disclosure is capable of automatically adjust the window period N. Since the server running the simulation does not require to process the behavior of the circuits every clock cycle, the resource usage may be reduced and the efficiency of running the simulation may be increased.

What is claimed is:

1. A method for system simulation, comprising:
simulating at least one operation of a first circuit during N clock periods based on a first model and at least one parameter of a simulation granularity, wherein the first model is corresponding to the first circuit and N is a positive integer; and
adjusting the at least one parameter of the simulation granularity based on at least one input signal corresponding to the first model or at least one output signal corresponding to the first model to adjust a value of N.

2. The method of claim 1, wherein the at least one parameter of the simulation granularity is selected from the group consisting of the value of N, an upper threshold of N, a lower threshold of N, an error value of timing sequence, an upper threshold of the error value of timing sequence, a lower threshold of the error value of timing sequence, a variation threshold of a signal rate, and any combination thereof.

3. The method of claim 1, wherein the step of adjusting the at least one parameter of the simulation granularity based on the at least one input signal corresponding to the first model or the at least one output signal corresponding to the first model to adjust the value of N comprises:
calculating a signal rate based on an amount of the at least one input signal or an amount of the at least one output signal; and
selectively adjusting the at least one parameter of the simulation granularity based on whether the signal rate increases.

4. The method of claim 3, wherein if the signal rate increases, the step of selectively adjusting the at least one parameter of the simulation granularity comprises:
determining whether an increment of the signal rate is lower than a variation threshold;
maintaining the at least one parameter of the simulation granularity if the increment is less than the variation threshold; and
selectively adjusting the at least one parameter of the simulation granularity if the increment is not less than the variation threshold.

5. The method of claim 4, wherein the step of selectively adjusting the at least one parameter of the simulation granularity if the increment is not less than the variation threshold comprises:
determining whether the value of N is larger than a lower threshold;
adjusting the at least one parameter of the simulation granularity to decrease the value of N if the value of N is larger than the lower threshold; and
maintaining the at least one parameter of the simulation granularity if the value of N is not larger than the lower threshold.

6. The method of claim 3, wherein if the signal rate does not increase, the step of selectively adjusting the at least one parameter of the simulation granularity comprises:
determining whether a decrement of the signal rate is less than a variation threshold;
maintaining the at least one parameter of the simulation granularity if the decrement is less than the variation threshold; and
selectively adjusting the at least one parameter of the simulation granularity if the decrement is not less than the variation threshold.

7. The method of claim 6, wherein the step of selectively adjusting the at least one parameter of the simulation granularity if the decrement is not less than the variation threshold comprises:
determining whether the value of N is less than an upper threshold;
adjusting the at least one parameter of the simulation granularity to increase the value of N if the value of N is less than the upper threshold; and
maintaining the at least one parameter of the simulation granularity if the value of N is not less than the upper threshold.

8. The method of claim 1, further comprising calculating an error value of timing sequence to adjust the at least one output signal.

9. The method of claim 8, wherein the step of calculating the error value of timing sequence to adjust the at least one output signal comprising:
delaying to output the at least one output signal when the error value of timing sequence is less than zero; and
outputting the at least one output signal in advance when the error value of timing sequence is larger than zero.

10. The method of claim 1, further comprising:
adjusting the at least one parameter of the simulation granularity to decrease the value of N when an error value of timing sequence is larger than an upper threshold of error value of timing sequence; and
adjusting the at least one parameter of the simulation granularity to increase the value of N when the error value of timing sequence is less than a lower threshold of error value of timing sequence.

11. A method for system simulation, comprising:
selectively simulating a first circuit in a cycle mode, an event mode, or a window mode based on a signal rate;
when simulating the first circuit in the window mode, simulating at least one operation of the first circuit during N clock periods based on a first model and at least one parameter of a simulation granularity, wherein the first model is corresponding to the first circuit and N is a positive integer; and
adjusting the at least one parameter of the simulation granularity based on the signal rate to adjust a value of N, wherein the signal rate is corresponding to at least one input signal corresponding to the first model or at least one output signal corresponding to the first model.

12. The method of claim 11, wherein the at least one parameter of the simulation granularity is selected from the group consisting of the value of N, an upper threshold of N, a lower threshold of N, an error value of timing sequence, an upper threshold of the error value of timing sequence, a lower threshold of the error value of timing sequence, a variation threshold of the signal rate, and any combination thereof.

13. The method of claim 11, wherein the step of adjusting the at least one parameter of the simulation granularity based on the at least one input signal corresponding to the first model or the at least one output signal corresponding to the first model to adjust N comprises:
calculating a signal rate based on an amount of the at least one input signal or an amount of the at least one output signal; and
selectively adjusting the at least one parameter of the simulation granularity based on whether the signal rate increases.

14. The method of claim 13, wherein if the signal rate increases, the step of selectively adjusting the at least one parameter of the simulation granularity comprises:
determining whether an increment of the signal rate is lower than a variation threshold;
maintaining the at least one parameter of the simulation granularity if the increment is less than the variation threshold; and
selectively adjusting the at least one parameter of the simulation granularity if the increment is not less than the variation threshold.

15. The method of claim 14, wherein the step of selectively adjusting the at least one parameter of the simulation granularity if the increment is not less than the variation threshold comprises:
determining whether the value of N is larger than a lower threshold;
adjusting the at least one parameter of the simulation granularity to decrease the value of N if the value of N is larger than the lower threshold; and
switching to the cycle mode to simulate the first circuit if the value of N is not larger than the lower threshold.

16. The method of claim 13, wherein if the signal rate does not increase, the step of selectively adjusting the at least one parameter of the simulation granularity comprises:
determining whether a decrement of the signal rate is less than a variation threshold;
maintaining the at least one parameter of the simulation granularity if the decrement is less than the variation threshold; and
selectively adjusting the at least one parameter of the simulation granularity if the decrement is not less than the variation threshold.

17. The method of claim 16, wherein the step of selectively adjusting the at least one parameter of the simulation granularity if the decrement is not less than the variation threshold comprises:
determining whether the value of N is less than an upper threshold;
adjusting the at least one parameter of the simulation granularity to increase the value of N if the value of N is less than the upper threshold; and
switching to the event mode to simulate the first circuit when the value of N is not less than the upper threshold.

18. The method of claim 11, further comprising calculating an error value of timing sequence to adjust the at least one output signal.

19. The method of claim 18, wherein the step of calculating the error value of timing sequence to adjust the at least one output signal comprising:
delaying to output the at least one output signal when the error value of timing sequence is less than zero; and
outputting the at least one output signal in advance when the error value of timing sequence is larger than zero.

20. The method of claim 11, further comprising:
adjusting the at least one parameter of the simulation granularity to decrease the value of N when an error value of timing sequence is larger than an upper threshold of error value of timing sequence; and
adjusting the at least one parameter of the simulation granularity to increase the value of N when the error value of timing sequence is less than a lower threshold of error value of timing sequence.

21. The method of claim 11, wherein simulating the first circuit with the cycle mode, the method comprises:
calculating the signal rate based on an amount of the at least one input signal or an amount of the at least one output signal; and
switching to the window mode to simulate the first circuit when the signal rate is less than an upper threshold.

22. The method of claim 11, wherein simulating the first circuit with the event mode, the method comprises:
calculating the signal rate based on an amount of the at least one input signal or an amount of the at least one output signal; and
switching to the window mode to simulate the first circuit when the signal rate is larger than an lower threshold.

23. A non-transitory computer-readable recording medium for storing at least one program, the at least one program causing a processor to perform the method according to claim 1 after the at least one program is loaded on a computer and is executed.

24. A non-transitory computer-readable recording medium for storing at least one program, when the at least one program executed by a device, the device performing the method according to claim 1.
